(19) United States
(12) Patent Application Publication
(10) Pub. No.: US 2025/0253740 A1
(43) Pub. Date: Aug. 7, 2025

(54) FLUID-COOLED, ROTATING ELECTRICAL MACHINE HAVING A DRY AIR GAP

(71) Applicant: BHE Turbomachinery, LLC, Portland, OR (US)

(72) Inventor: Henry K. Obermeyer, Wellington, CO (US)

(21) Appl. No.: 19/047,130

(22) Filed: Feb. 6, 2025

Related U.S. Application Data
(60) Provisional application No. 63/550,357, filed on Feb. 6, 2024.

(51) Int. Cl. H02K 9/197; H02K 5/20; H02K 7/00; H02K 9/22

(52) U.S. Cl. CPC H02K 9/197; H02K 5/203; H02K 7/003; H02K 9/225; H02K 2201/03

(57) ABSTRACT

A fluid-cooled, rotating electrical machine having a dry air gap. The rotating electrical machine includes a rotor assembly, a stator assembly, an annular air gap, and a fluid-tight barrier. The stator assembly is on a common center with the rotor assembly and has a stator core, stator coils passing through the stator core that have stator end-coils, and an ascending coolant channel extending axially through the stator core. The air gap is radially between the stator assembly and the rotor assembly. The fluid-tight barrier between the stator end-coils and the air gap.

### CROSS-REFERENCES TO RELATED APPLICATIONS

This patent application claims the benefit of provisional Application No. 63/550,357 filed Feb. 6, 2024. That application is incorporated into the present disclosure in its entirety by this reference.

### TECHNICAL FIELD

The disclosed technology relates to the cooling of motors and generators in general and relates more specifically to the cooling of large, submersible motors and generators suitable for utility-scale hydropower pumped storage projects or large submersible pumps.

### BACKGROUND

The operation of a large motor or generator with the air gap full of oil or other coolant results in unnecessary viscous losses and heating of the coolant. Turbulence in the air gap can damage laminations, coils, wedges, and can potentially result in cavitation damage.

Configurations of the disclosed technology address shortcomings in the prior art.

### BRIEF DESCRIPTION OF THE DRAWINGS

FIG. 1 is a sectional view of a machine assembly that includes a liquid-cooled, rotating electrical machine having an internal rotor, according to an example configuration.

FIG. 2 is an isometric view of a hydromotive machine portion of the machine assembly of FIG. 1.

FIG. 3 is a partially exploded, isometric view of portions of a stator assembly of the rotating electrical machine of FIG. 1.

FIG. 4 is a sectional view of a machine assembly that includes a liquid-cooled, rotating electrical machine having an external rotor, according to an example configuration.

FIG. 5 isolates the rotating portions of the machine assembly of FIG. 4.

FIG. 6 isolates the non-rotating portions of the machine assembly of FIG. 4.

FIG. 7 is a sectional view of a refrigerant-cooled, rotating electrical machine having an internal rotor, according to an example configuration.

FIG. 8 is a partial sectional view of a refrigerant-cooled, rotating electrical machine having an internal rotor, according to another example configuration.

FIG. 9 is a sectional view of the rotating electrical machine of FIG. 8.

FIG. 10 is a sectional view of a refrigerant-cooled, rotating electrical machine having an internal rotor, according to another example configuration.

FIG. 11 is a sectional view of a magnetic motor, according to an example configuration.

FIG. 12 is a radially inward view of a descending coolant channel, according to an example configuration.

FIG. 13 is a sectional view of a descending coolant channel at the interface between the stator core and stator housing, according to an example configuration.

FIG. 14 is a partial plan view of ascending coolant channels and descending coolant channels, according to an example configuration.

FIG. 15 is a sectional view of an ascending coolant channel at the interface between the stator core and a stator coil, according to an example configuration.

### DETAILED DESCRIPTION

As described in this document, aspects are directed to a rotating electrical machine, such as a motor-generator, where fluid—subject to a temperature change or a phase change—is used to cool the stator while avoiding the viscous losses that would result from the shearing of fluid in the gap between the rotor and the stator. Such a dry gap (referred to as an “air gap” here) also avoids cavitation damage in the gap. Specifically, configurations seek to isolate the heat-transfer fluid from the gap by providing a fluid-tight barrier between the stator and the gap. In configurations, the fluid-tight barrier is also non-magnetic and non-conductive. And, should heat-transfer fluid nonetheless leak to the rotor-side of the fluid-tight barrier, configurations provide a pump and conduits to return the heat-transfer fluid to the stator-side of the fluid-tight barrier. Configurations also include heat pipe cooling of the rotor. This heat pipe cooling of the rotor helps to compensate for the reduction in heat transfer from the rotor to the stator caused by the presence of the fluid-tight barrier.

The drawings included with this disclosure are primarily directed toward submersible pumps and pump-turbines. Nonetheless, the disclosed cooling means and motor-generator configurations may be applicable to a broad range of applications, including drive motors for electric vehicles.

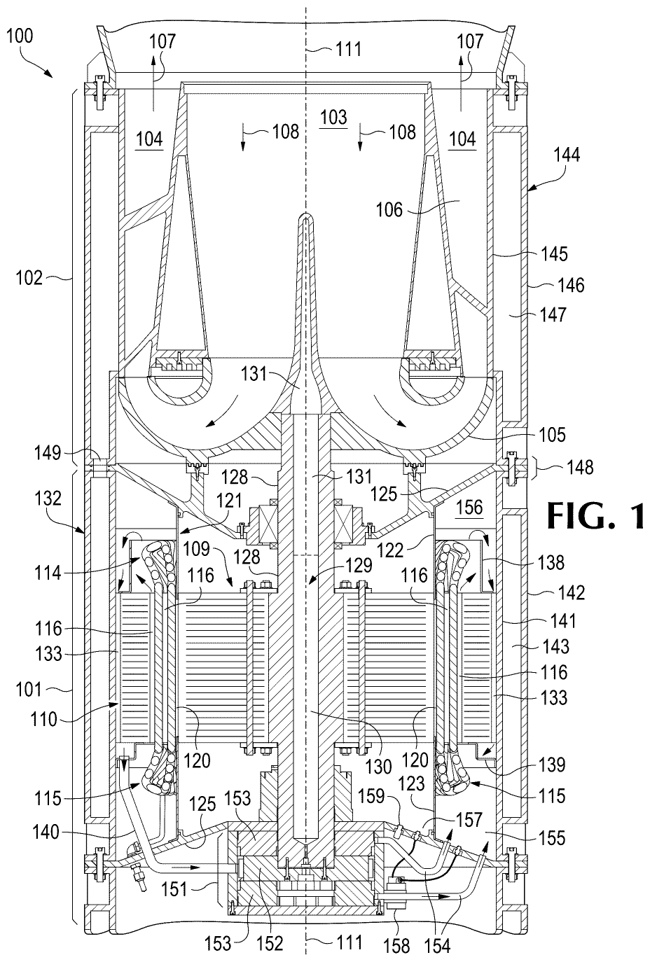

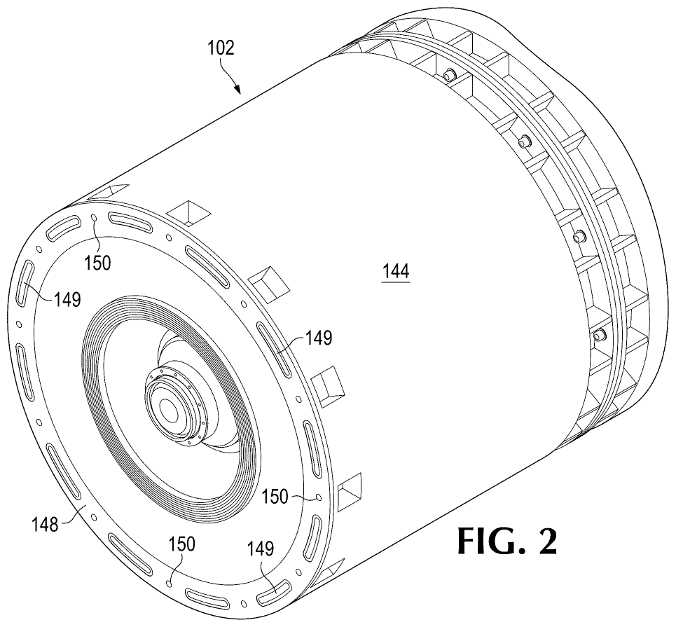

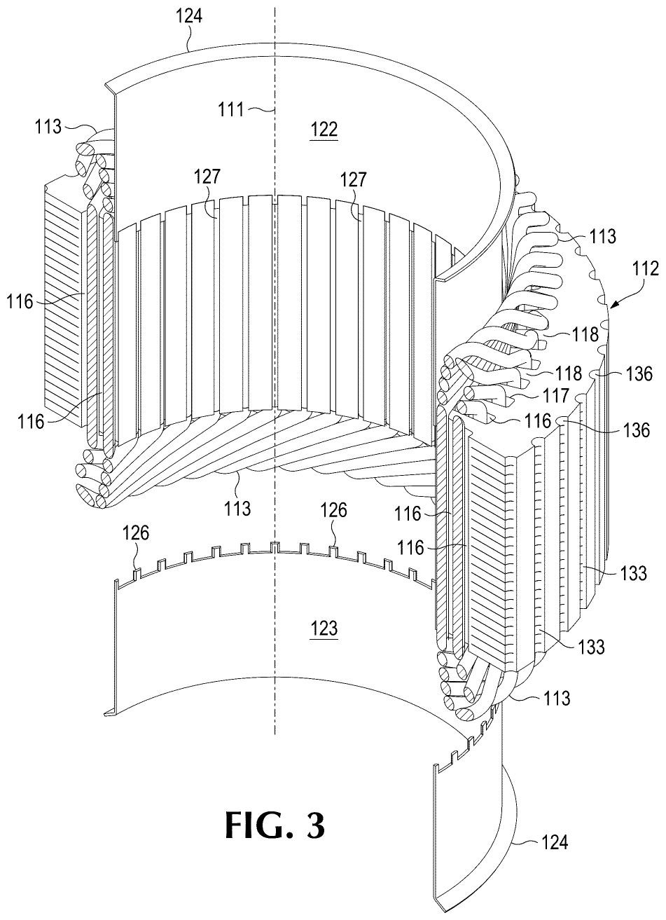

FIG. 1 is a sectional view showing portions of a machine assembly that includes a liquid-cooled, rotating electrical machine having an internal rotor, according to an example configuration. FIG. 2 is an isometric view of a hydromotive machine portion of the machine assembly of FIG. 1. FIG. 3 is a partially exploded, isometric view of portions of a stator assembly of the rotating electrical machine of FIG. 1. As illustrated in FIGS. 1-3, a machine assembly 100 may include a rotating electrical machine 101 and a hydromotive machine 102. The rotating electrical machine 101 may be, as examples, a motor, a generator, or a motor-generator that functions as both a motor and a generator.

The hydromotive machine 102 may be, as examples, a pump, a reversible pump-turbine, a turbine, a blower, a compressor, a turbocharger, a supercharger, or a gas turbine. As illustrated in FIG. 1, a hydromotive machine 102, in this case a reversible pump-turbine, may include a pump inlet 103, a pump outlet 104, an impeller 105, and a pump diffuser 106. During pumping mode of the reversible pump-turbine, water or other fluid enters the example hydromotive machine 102 through the pump inlet 103. The impeller 105 increases the velocity of the fluid and, in the illustrated embodiment, also diverts the fluid 180 degrees from the direction of flow 108 through the pump inlet 103. The pump diffuser 106 reduces the velocity of the fluid, thereby increasing the pressure of the fluid, before the fluid exits through the pump outlet 104. As illustrated, the direction of flow 107 through the pump outlet 104 is opposite to the direction of flow 108 through the pump inlet 103. In pump mode, the impeller 105 may be driven by the rotating electrical machine 101, which is acting as a motor. Such a hydromotive machine 102 is more fully explained in patent U.S. Pat. No. 11,300,093.

The flow directions of FIG. 1 are reversed when the reversible pump-turbine operates in turbine mode. During turbine mode, water or other fluid enters the reversible pump-turbine through what is the pump diffuser 106 in pumping mode. The impeller 105 functions as a runner during turbine mode, turning energy from the moving fluid into kinetic energy of the runner. The pump inlet 103 functions as the turbine diffuser in turbine mode. The kinetic energy of the runner can be used, as an example, to generate electricity by driving the rotating electrical machine 101 in reverse so that it functions as an electric power generator.

As noted above, the hydromotive machine 102 may be, as examples, a pump, a reversible pump-turbine, or a turbine, among other possibilities. For simplicity and readability, however, the terminology of a pump or the pump mode of the reversible pump-turbine is used in this disclosure when describing the configurations illustrated in FIGS. 1-7.

As illustrated in FIGS. 1-3, the rotating electrical machine 101 includes a rotor assembly 109 and a stator assembly 110. The rotor assembly 109 may be, as examples, an induction rotor, a synchronous reluctance rotor, a permanent magnet rotor, a wound induction motor rotor, or a brushless doubly fed induction rotor.

The stator assembly 110 is on a common center with the rotor assembly 109. The common center coincides with the axis of rotation 111 of the rotor assembly 109. In the configuration of FIGS. 1-3, the stator assembly 110 is radially external to the rotor assembly 109. The stator assembly 110 has a stator core 112 and stator coils 113 passing through the stator core 112. The stator coils 113 have stator end-coils, including upper stator end-coils 114 and lower stator end-coils 115. Ascending coolant channels 116 extend axially through the stator core 112. The ascending coolant channels 116 may be formed, for example, by extending the stator slots 117 between stator teeth 118, as best seen in FIG. 3. This provides heat-transfer fluid immediately adjacent to the stator coils 113 within the stator slots 117. In configurations, an ascending coolant channel 116 may also or instead be provided between two stator coils 113 that share a single stator slot 117 by, for example, inserting perforated spacers between the adjacent stator coils 113, the perforated spacers allowing heat-transfer fluid to flow between the adjacent stator coils 113. In configurations, an ascending coolant channel 116 may also or in addition be within a hollow conductor within the stator coils 113, which, instead of carrying current, is configured as a conduit for heat-transfer fluid. As illustrated, the heat-transfer fluid passes through the ascending coolant channels 116 by natural convection since the heat-transfer fluid is heated as it flows upward through the ascending coolant channels 116 as it absorbs heat from the stator assembly 110. In other configurations, the natural convection may be augmented or replaced with forced convection from, for example, pumping.

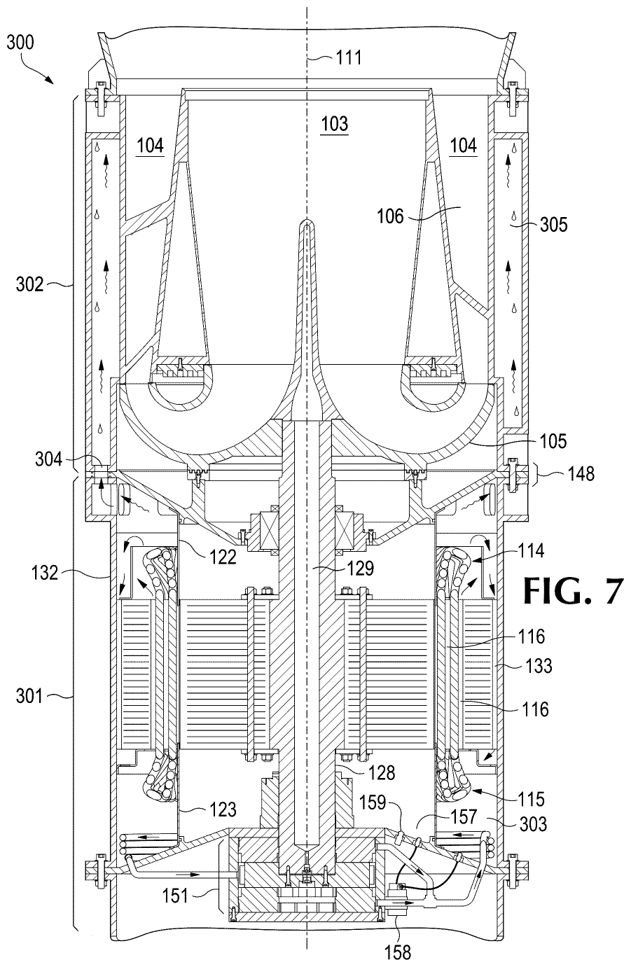

In the configuration of FIGS. 1-3, the heat-transfer fluid may be, for example, a lubricating oil, such as mineral oil, or another liquid coolant. The discussion of FIG. 7 below discusses a similar system that uses a refrigerant as the heat-transfer fluid to cool the stator coils.

As described, the ascending coolant channels 116 restrict neither the copper cross section of the stator coils 113 nor the iron cross section of the stator teeth 118. The space occupied by the ascending cooling channels within the stator slots 117 simply requires slightly more back iron. Additional ascending coolant channels 116 may be added to reduce temperatures yet further, with the understanding that stator-core length may have to be increased to limit iron losses and copper losses in the interest of efficiency.

The ascending coolant channel 116 may be configured to promote turbulent flow and, thus, higher heat transfer coefficients, by using core laminations of differing profiles. This may be accomplished by using location-in-stack-specific laser-cut laminations or by trimming the interior surfaces of the ascending coolant channels 116 in otherwise identical laminations produced on a press. Trimming might be accomplished with a secondary press operation or by laser cutting. Either way, the end result is that the notch, or void 119, for the ascending coolant channel 116 in each layer of the lamination differs from the void 119 in the immediately adjacent layers (i.e. just above and just below the particular layer). For example, the notch in the particular layer may be offset from the notch in the layer just above and just below the particular layer. Other patterns are also possible, such as the stepped void 119 illustrated in FIG. 15. Laser cutting of laminations makes feasible the customization (and corresponding labelling) of the individual laminations described here.

It is noted that the stator end-coils are designated “upper” and “lower” and the coolant channels are designated “ascending” because in FIGS. 1-3, “up” is toward the top of the drawings, while “down” is toward the bottom of the drawings. As noted, some configurations utilize natural convection, where relatively hot fluids tend to travel upward and relatively cool fluids tend to travel downward. Unless noted, this same convention is used for each of FIGS. 1-7. Even so, the disclosed technology may be modified for installations that may be inclined, horizontal, or other varying in orientation from what is illustrated, or subject to zero-or micro-gravity. For example, in the case of orientations or accelerations that differ from what is illustrated, the upper coolant reservoir 156 may be an accumulator analogous to an oil pressure accumulator or household water pressure tank.

An annular air gap 120 is radially between the stator assembly 110 and the rotor assembly 109. The air gap 120 is dry because a fluid-tight barrier 121 substantially blocks the passage of heat-transfer fluid from the stator end-coils to the air gap 120. As used in this context, “substantially blocks” means largely or essentially obstructs the heat-transfer fluid, without requiring a perfect seal. (Indeed, configurations described below allow for the return to the stator-side of the fluid-tight barrier 121 any heat-transfer fluid that leaked to the rotor-side of the fluid-tight barrier 121.) Accordingly, in operation heat-transfer fluid immerses the stator end-coils but not the air gap 120. Immersion of the stator end-coils helps to cool the stator assembly 110. In the configuration illustrated in FIGS. 1-3, the heat-transfer fluid is a liquid coolant. In other configurations described below, the heat-transfer fluid is a refrigerant, or evaporating fluid.

The fluid-tight barrier 121 is between the stator end-coils and the air gap 120. In configurations, the fluid-tight barrier 121 includes an upper barrier 122 that is between the upper stator end-coils 114 and the air gap 120 and a lower barrier 123 between the lower stator end-coils 115 and the air gap 120. Each of the upper barrier 122 and the lower barrier 123 is secured to the stator core 112. As illustrated, each of the upper barrier 122 and the lower barrier 123 is substantially cylindrical. As used in this context, “substantially cylindrical” means largely or essentially having the form of a right circular cylinder without requiring perfect cylindricality. Indeed, as illustrated in FIG. 3, each of the upper barrier 122 and the lower barrier 123 may include a lip 124 to facilitate positioning of the barrier to the bulkhead 125, as illustrated, or to another non-rotating structural member.

With particular reference to FIG. 3, the upper barrier 122 is illustrated in its functional position with integral tabs 126 secured into corresponding notches 127 in the stator slots 117. This arrangement securely holds the upper barrier 122 away from the rotor assembly 109 during assembly and operation. The lower barrier 123 is illustrated as being separated from the stator core 112 to better shown the integral tabs 126. The lower barrier 123 is assembled to the stator core 112 as described for the upper barrier 122, namely by securing the integral tabs 126 into corresponding notches 127 in the stator slots 117. The upper barrier 122 and the lower barrier 123 are preferably made from electrically non-conductive material, such as glass-reinforced plastic, to avoid additional eddy current losses. An example method of installation would include curing glass-reinforced plastic over a mandrel of approximately the same diameter as the stator-core bore, followed by trimming the edges and cutting the integral tabs 126 by waterjet cutting. The upper barrier 122 and the lower barrier 123 are preferably made from non-magnetic material to avoid additional hysteresis losses.

It should be noted that, in accordance with an alternative embodiment of the disclosed technology, that the upper barrier 122 or the lower barrier 123 may be configured as a non-cylindrical shape, such as a cone. This would prevent rotor insertion or extraction from one direction, but would provide greater clearance for circulation of heat-transfer fluid adjacent to the stator coils 113. Such a configuration could be used in conjunction with stator end-coils extending toward the axis of rotation 111 in a manner that would prevent rotor insertion into or extraction from that end of the stator assembly 110. The coils in such a configuration could be slightly shorter, thus reducing initial cost as well as reducing I²R losses (power losses caused by the flow of current (I) through resistance (R)) while improving efficiency.

As noted, the stator assembly 110 is on a common center with the rotor assembly 109, which coincides with the axis of rotation 111 of the rotor assembly 109. A shaft 128 that is coupled to the rotor assembly 109 coincides with the common center. Because the upper barrier 122 and the lower barrier 123 may block heat transfer from the rotor assembly 109 to the stator assembly 110, additional means may be needed to cool the rotor assembly 109. Accordingly, as illustrated the shaft 128 includes a heat pipe 129 within the shaft 128. The heat pipe 129 cools the rotor assembly 109 by absorbing heat from the rotor assembly 109 in the evaporator portion 130 of the heat pipe 129. In configurations, the condenser portion 131 of the heat pipe 129 is in, or extends into, the pump inlet 103 of the hydromotive machine 102, where heat from the heat pipe 129 may be transferred to the fluid passing through the hydromotive machine 102 when operating. An example of this is illustrated in FIG. 1. Such a configuration provides a flow of cooling fluid to the condenser without increasing operating cost or significant additional capital equipment.

In configurations, a stator housing 132 is thermally coupled to the stator assembly 110. In such configurations, the stator core 112 may include descending coolant channels 133 that are thermally coupled to the stator housing 132. In configurations, the descending coolant channels 133 follow a spiral path between the stator core 112 and the stator housing 132. Stated another way, each descending coolant channel 133 may trace out a path that is cylindrically helical between the upper portion 134 of the stator core 112 (i.e. near the upper stator end-coils 114) and the lower portion 135 of the stator core 112 (i.e. near the lower stator end-coils 115). Accordingly, the sectional view of FIG. 1 intersects several such spiraling, descending coolant channels 133. Each descending coolant channel 133 may be configured to generate turbulent flow of the heat-transfer fluid within the descending coolant channel 133. For example, the spiral may be formed from staggered voids 136 in the laminations of the stator core 112. As best shown in FIGS. 12 and 14, a notch, or void 136, in a lamination layer 137 may be offset from (but still overlapping with) the void 136 in the lamination layers 137 immediately above and below such that, when the pattern continues, the resulting path is a spiral shape that promotes turbulent flow. Such irregularities increase the level of turbulence and, likewise, the heat transfer coefficient, allowing more heat to pass from the heat-transfer fluid to the stator housing 132. A single lamination layer 137 may have voids 136 for more than one descending coolant channel 133, which voids 136 are circumferentially spaced apart in the lamination layer 137.

Also or instead of the staggered voids 136, the laminations of the stator core 112 can be offset as illustrated in FIG. 13. Such steps increase the heat transfer from the descending coolant channel 133 to the stator housing 132.

Returning to FIGS. 1-3, a baffle 138 allows heated heat-transfer fluid to enter the descending coolant channels 133. After exiting the descending coolant channels 133, the cooled heat-transfer fluid passes into a descending-coolant-channel manifold 139 and then out of the descending-coolant-channel manifold 139 through a thrust-bearing-assembly inlet conduit 140.

In the illustrated configuration the stator housing 132 includes an inner wall 141 that is thermally coupled to the stator assembly 110. Hence, for example, the inner wall 141 of the stator housing 132 may be in physical contact with the stator core 112 or separated only by heat-transfer fluid. In the illustrated configuration, the stator housing 132 also includes an outer wall 142 and a stator-housing heat-pipe evaporator 143 that is in the annular space between the inner wall 141 and the outer wall 142 of the stator housing 132.

In configurations, the hydromotive machine 102 may further include a diffuser housing 144 having an inner diffuser housing 145 that is radially external to the pump diffuser 106 and an outer diffuser housing 146 that is radially external to the inner diffuser housing 145. A diffuser heat-pipe condenser 147 is in an annular space between the inner diffuser housing 145 and the outer diffuser housing 146. The inner diffuser housing 145 is in contact with high-velocity fluid within the pump diffuser 106 whenever the hydromotive machine 102 is in operation; so it provides a good condensing surface.

In the illustrated configuration, the machine assembly 100 includes a flange 148 for coupling together the stator housing 132 and the hydromotive machine 102. The flange 148 includes one or more heat-pipe ports 149 to connect the stator-housing heat-pipe evaporator 143 to the diffuser heat-pipe condenser 147. In configurations, the heat-pipe ports 149 alternate with the flange bolt holes 150 about the flange 148, as best seen in FIG. 2. Accordingly, hot vapor from the stator-housing heat-pipe evaporator 143 may flow upward through the heat-pipe ports 149 into the diffuser heat-pipe condenser 147. Similarly, relatively cool liquid from the heat pipe 129 may flow downward through the heat-pipe ports 149 and back into the stator-housing heat-pipe evaporator 143 to repeat the cycle.

Thrust loads of the shaft 128 are carried by a thrust bearing assembly 151, which includes a thrust disk 152 in conjunction with tilting-pad thrust bearings 153. In configurations, the thrust bearing assembly 151 may act as a viscosity pump. Specifically, the thrust bearing assembly 151 accepts cooled heat-transfer fluid from the descending-coolant-channel manifold 139 through the thrust-bearing-assembly inlet conduit 140 and delivers cooled heat-transfer fluid through thrust-bearing-assembly outlet conduits 154 to a lower coolant reservoir 155 (between the lower barrier 123 and the stator housing 132), where the lower stator end-coils 115 are immersed in heat-transfer fluid. The heat-transfer fluid flows out of the lower coolant reservoir 155 through the ascending coolant channels 116 to an upper coolant reservoir 156, where the upper stator end-coils 114 are immersed in heat-transfer fluid. As noted above, the baffle 138 allows heated heat-transfer fluid to enter the descending coolant channels 133 to continue the cycle.

To reduce the occurrence of metallic wear material that may hinder the circulation of the heat-transfer fluid, the materials for the thrust bearing assembly 151 should be carefully selected. For example, the tilting-pad thrust bearings 153 made be made from polytetrafluoroethylene (PTFE), while the opposing surfaces of the shaft 128 and thrust disk 152 may have an aluminum oxide coating. Configurations may also include magnetic debris traps and fine particulate filters in the flow path of the heat-transfer fluid, such as between the thrust bearing assembly 151 and the lower coolant reservoir 155.

Even with the lower barrier 123 and the upper barrier 122, it is possible for heat-transfer fluid to leak to the rotor-assembly side of the lower barrier 123 and the upper barrier 122. In the event that heat-transfer fluid collects in a sump 157 on the rotor-assembly side of the lower barrier 123, in the illustrated configuration a pump 158 returns the heat-transfer fluid to the lower coolant reservoir 155. The pump 158 may be activated by a float switch, pressure sensor, or other fluid level sensor 159.

Accordingly, in the configuration illustrated in FIGS. 1-3, the stator assembly 110 is cooled by the absorption of heat by the heat-transfer fluid immersing the stator end-coils and also passing through the ascending coolant channels 116 by natural convection, preferably under turbulent flow conditions as described. Heat from the heat-transfer fluid is then transferred to the stator housing 132, specifically the inner wall 141 of the stator housing 132 in the illustrated configuration. As the heat-transfer fluid cools, it descends through the descending coolant channels 133 by natural convection. Again, this is preferably under turbulent flow conditions. The stator housing 132, in turn, transfers the heat to the heat-pipe evaporator that is between the inner wall 141 and the outer wall 142 of the stator housing 132. And the heat-pipe evaporator dissipates heat through its corresponding condenser, which, via the heat-pipe ports 149 in the flange 148, is in the diffuser housing 144 of the hydromotive machine 102.

Likewise, in the configuration illustrated in FIGS. 1-3, the rotor assembly 109 is cooled since heat from the rotor assembly 109 is transferred to the shaft 128 by physical contact and, then, from the shaft 128 to the heat pipe 129 within the shaft 128. Specifically, heat from the shaft 128 is absorbed by the evaporator portion 130 of the heat pipe 129. The heat pipe 129 loses heat energy through its condenser portion, which extends into the pump inlet 103 of the hydromotive machine 102. Heat from the condenser portion 131 of the heat pipe 129 is transferred to the fluid (typically water or air) passing through the hydromotive machine 102 when the hydromotive machine 102 is operating in pumping mode or in turbine mode.

The net result is that configurations of the disclosed arrangement provide a more effective cooling system due to the circulation of heat-transfer fluid through the ascending cooling channels and the descending cooling channels, than a prior art, fully liquid filled, motor generator. Configurations of the disclosed arrangement also provide the superior efficiency of a motor generator with a dry (not liquid filled) air gap 120.

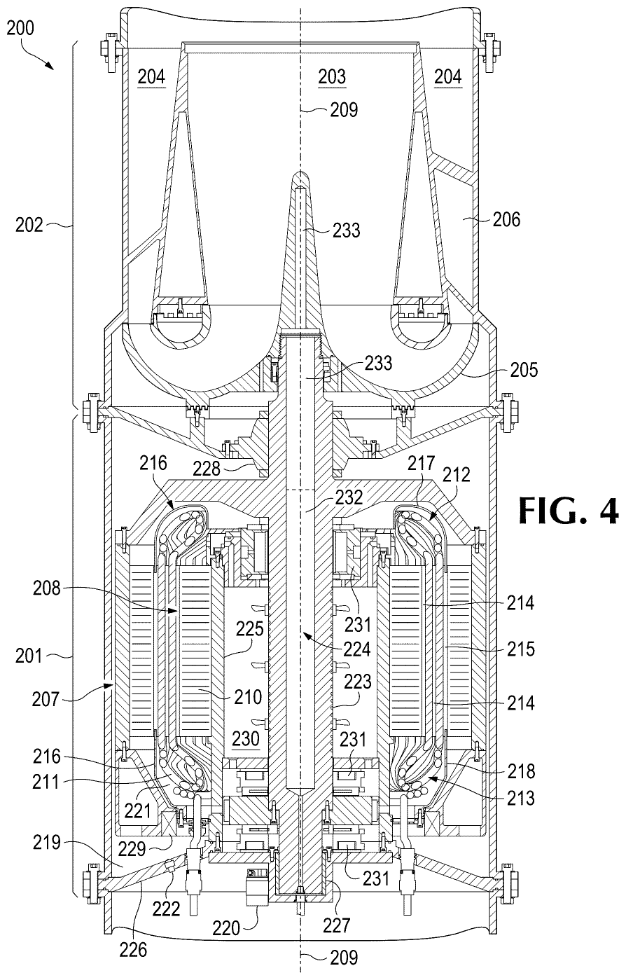

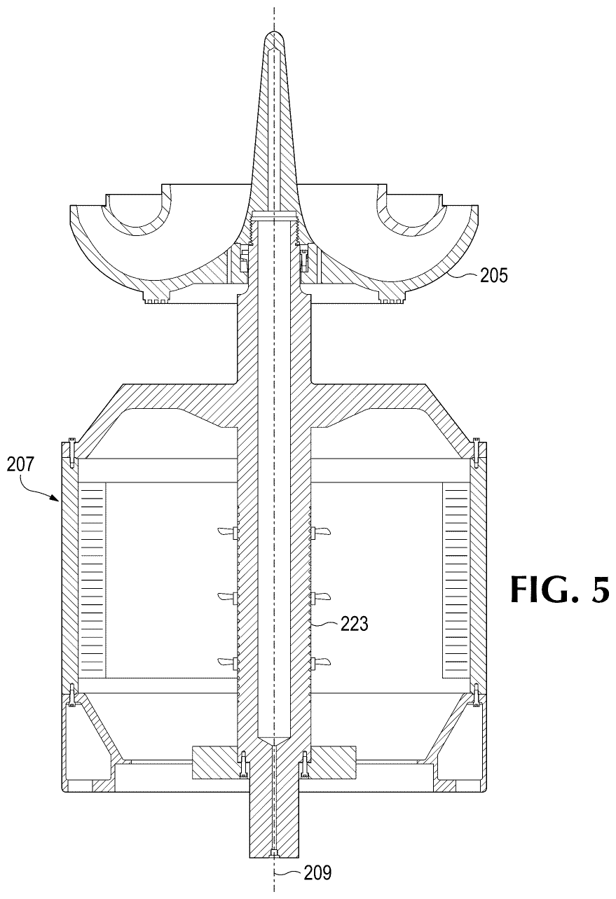

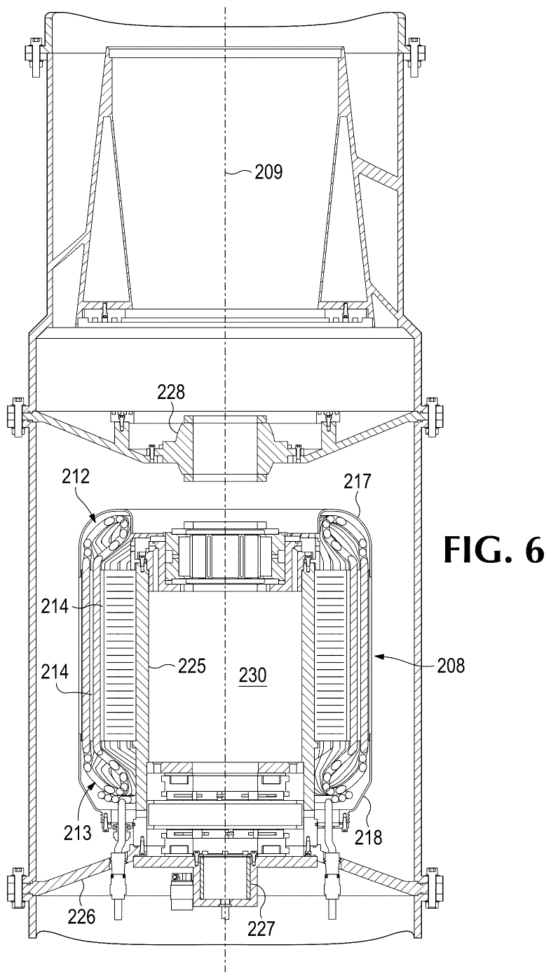

FIG. 4 is a sectional view showing portions of a machine assembly 200 that includes a liquid-cooled, rotating electrical machine 201 having an external rotor, according to an example configuration. The extra rotating inertia of an external-rotor motor-generator is of great benefit in hydroelectric applications in enhancing grid stability and reducing water hammer in penstocks. FIG. 5 isolates the rotating portions of the machine assembly 200 of FIG. 4. FIG. 6 isolates the non-rotating portions of the machine assembly 200 of FIG. 4. As illustrated in FIGS. 4-6, a machine assembly 200 may include a rotating electrical machine 201 and a hydromotive machine 202. The rotating electrical machine 201 may be, as examples, a motor, a generator, or a motor-generator that functions as both a motor and a generator.

The hydromotive machine 202 may be, as examples, a pump, a reversible pump-turbine, a turbine, a blower, a compressor, a turbocharger, a supercharger, or a gas turbine. As illustrated in FIG. 1, a hydromotive machine 202, in this case a reversible pump-turbine, may include an impeller 205, a pump inlet 203 upstream of the impeller 205, a pump outlet 204 downstream of the impeller 205, and a pump diffuser 206 between the impeller 205 and the pump outlet 204. Operation of the hydromotive machine 202 (i.e. the pumping mode and the turbine mode) is as described above for FIGS. 1-3.

As illustrated, the rotating electrical machine 201 includes a rotor assembly 207 and a stator assembly 208. As in FIGS. 1-3, the rotor assembly 207 of FIGS. 4-6 may be, as examples, an induction rotor, a synchronous reluctance rotor, a permanent magnet rotor, a wound induction motor rotor, or a brushless doubly fed induction rotor.

The stator assembly 208 is on a common center with the rotor assembly 207. The common center coincides with the axis of rotation 209 of the rotor assembly 207. In the configuration of FIGS. 4-6, the stator assembly 208 is radially internal to the rotor assembly 207. The stator assembly 208 has a stator core 210 and stator coils 211 passing through the stator core 210. The stator coils 211 have stator end-coils, including upper stator end-coils 212 and lower stator end-coils 213. Cooling channels 214 extend axially through the stator core 210. The cooling channels 214 of FIGS. 4-6 are as described above for the ascending coolant channels 116 of FIGS. 1-3 unless stated otherwise in this discussion.

An annular air gap 215 is radially between the stator assembly 208 and the rotor assembly 207. The air gap 215 is dry because a fluid-tight barrier 216 substantially blocks the passage of heat-transfer fluid from the stator end-coils to the air gap 215. Accordingly, in operation heat-transfer fluid immerses the stator end-coils but not the air gap 215. Immersion of the stator end-coils helps to cool the stator assembly 208. In the configuration illustrated in FIGS. 4-6, the heat-transfer fluid is a liquid coolant. In other configurations, the heat-transfer fluid is a refrigerant, or evaporating fluid.

The fluid-tight barrier 216 is between the stator end-coils and the air gap 215. In configurations, the fluid-tight barrier 216 includes an upper barrier 217 that is between the upper stator end-coils 212 and the air gap 215 and a lower barrier 218 between the lower stator end-coils 213 and the air gap 215. Each of the upper barrier 217 and the lower barrier 218 is secured to the stator core 210. The upper barrier 217 helps to contain heat-transfer fluid in an upper coolant reservoir around the upper stator end-coils 212, and the lower barrier 218 helps to contain heat-transfer fluid in a lower coolant reservoir 221 around the lower stator end-coils 213. The upper barrier 217 and the lower barrier 218 are preferably made from electrically non-conductive material, such as glass-reinforced plastic.

A sump 219 catches heat-transfer fluid that leaked from the stator assembly 208, such as between laminations or between conductors. A pump 220 returns the heat-transfer fluid to a lower coolant reservoir 221. The pump 220 may be activated by a float switch, pressure sensor, or other fluid level sensor 222. The heat-transfer fluid may circulate through the cooling channels 214 under pressure generated by the pump 220. In configurations, check valves are included to allow natural convection to serve as backup to the pump 220.

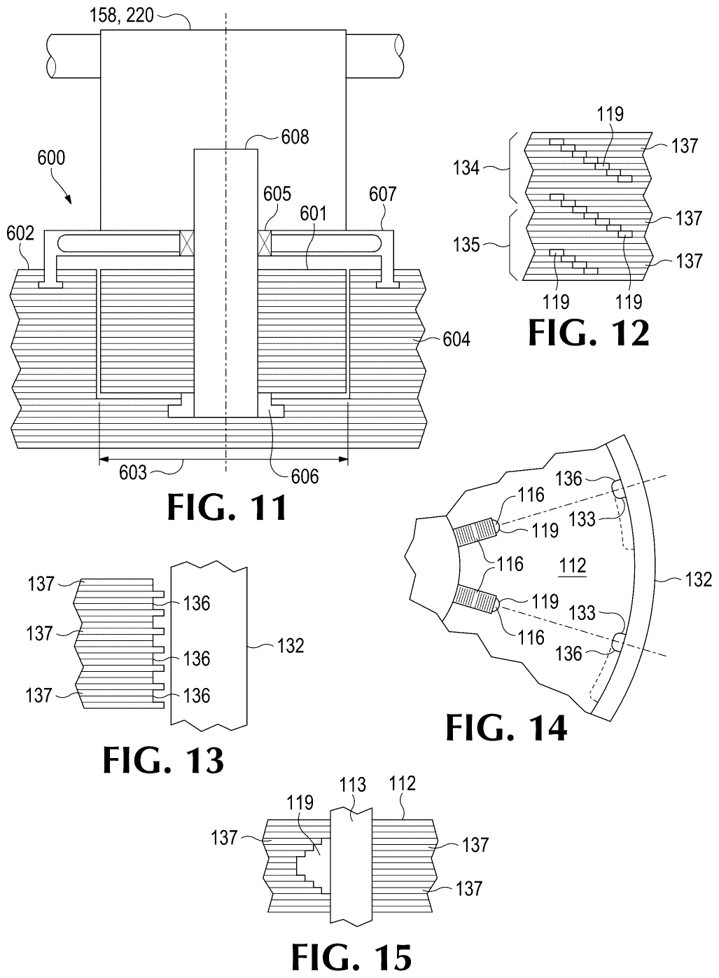

With particular reference to FIG. 11, in configurations the pump 220 is driven by magnetic motor 600 having a magnetic motor rotor 601 and a magnetic motor stator 602. The magnetic motor rotor 601 is magnetically driven by the locally rotating magnetic field in the back iron of the stator core 210. The magnetic motor rotor 601 may be any of several types, including squirrel cage induction, permanent magnet, and synchronous reluctance. As illustrated, the air-gap diameter 603 of the magnetic motor rotor 601 is about five percent of the diameter of the stator core 210. The magnetic motor stator 602 for the magnetic motor 600 is the same stator assembly 208 as for the main motor in which the magnetic motor 600 is installed. A cavity for installation of the magnetic motor rotor 601 is created by leaving holes in the laminations of the main stator assembly 208. In the back iron of the main stator assembly 208, where this magnetic motor 600 is located, the direction of the magnetic field rotates. The local back iron 604 thus forms the magnetic motor stator 602. As illustrated, an outboard bearing 605, and inboard bearing 606, and a bearing bracket 607 may be secured to holes, notches, slots, or the like in the appropriate laminations. The pump 220 may be driven by the magnetic motor 600 through a magnetic-motor shaft 608.

The magnetic motor rotor 601 can provide a fractional horsepower motor immediately adjacent to the medium- or high-voltage stator coils. Placement of a small motor immediately adjacent to medium- or high-voltage windings would otherwise be impractical from a wiring safety standpoint. And running tubing to remote motors and pumps would introduce many additional points of failure at significant installation expense.

While described here in the context of the external-rotor rotating electrical machine 201 of FIGS. 4-6, the concepts described above for the magnetic motor 600 also apply to the internal-rotor rotating electrical machine 101 of FIGS. 1-3.

Returning to FIGS. 4-6, as noted, the stator assembly 208 is on a common center with the rotor assembly 207, which coincides with the axis of rotation 209 of the rotor assembly 207. A rotating shaft 223 that is coupled to the rotor assembly 207 coincides with the common center. A heat pipe 224 is within the rotating shaft 223.

As illustrated, the stator assembly 208 also includes a tubular stator shaft 225 that torsionally secures the stator core 210 to a bulkhead 226, as illustrated, or to another non-rotating structural member. The tubular stator shaft 225 is preferably made of nonmagnetic material, such as austenitic stainless steel or manganese steel, to minimize penetration of alternating magnetic flux from the stator core 210 into the tubular stator shaft 225. In the illustrated configuration, the rotating shaft 223 is positioned within the tubular stator shaft 225 by a lower bearing 227 and an upper bearing 228. In configurations, an optional, preferably magnetic, bearing 229 stabilizes the lower end of the rotor assembly 207 to the tubular stator shaft 225.

The rotating electrical machine 201 further includes a chamber 230 between the tubular stator shaft 225 and the rotating shaft 223. The chamber 230 is configured to contain heat-transfer fluid. Hence, for example, the chamber 230 may be filled, or partially filled, with heat-transfer fluid to conduct heat from the tubular stator shaft 225 to the rotating shaft 223. In configurations, the heat-transfer fluid in the chamber 230 also lubricates the lower bearing 227 and the upper bearing 228 as well as other bearings 231 that create a moment, shear, and thrust connection between the tubular stator shaft 225 and the rotating shaft 223.

The rotating shaft 223 conducts heat to the evaporator portion 232 of the heat pipe 224 within the rotating shaft 223. In configurations, the condenser portion 233 of the heat pipe 224 is in, or extends into, the pump inlet 203 of the hydromotive machine 202, where heat from the heat pipe 224 may be transferred to the fluid passing through the hydromotive machine 202 when operating. An example of this is illustrated in FIG. 4. The condensed heat-transfer fluid returns to the condenser portion 233 of the heat pipe 224 through a combination of gravity and centrifugal force. The centrifugal force of the rotating shaft 223 keeps the condensed heat-transfer fluid confined to the walls of the heat pipe 224 and out of the way of the vapor stream flowing from the relatively hot, evaporator portion 232 of the heat pipe 224 to the relatively cool, condenser portion 233 of the heat pipe 224.

Accordingly, in the configuration illustrated in FIGS. 4-6, heat from the stator coils is absorbed by the heat-transfer fluid immersing the stator end-coils and also passing through the cooling channels 214, preferably under turbulent flow conditions as described. Also or instead, heat from the stator coils also conducts through the stator core 210 to the tubular stator shaft 225. The heat-transfer fluid within the chamber 230 between the tubular stator shaft 225 and the rotating shaft 223 conducts the heat from the tubular stator shaft 225 to the rotating shaft 223. Heat is then conducted from the rotating shaft 223 to the heat pipe 224 within the rotating shaft 223, where it is dissipated by the condenser, which extends into the pump inlet 203 of the hydromotive machine 202.

Accordingly, aspects of this disclosure teach through-the-shaft heat-pipe cooling of the stator assembly 208 of an external rotor machine, extending the advantages of the disclosed cooling methods to external rotor machines that may otherwise be power limited by high operating temperatures.

FIG. 7 is a sectional view showing portions of a refrigerant-cooled, rotating electrical machine 301 having an internal rotor, according to an example configuration. As illustrated in FIG. 7, a machine assembly 300 may include a rotating electrical machine 301 and a hydromotive machine 302. Except as noted in discussion that follows, the configuration of FIG. 7 is the same as the configuration of FIGS. 1-3. The biggest distinction is that, in the configuration of FIG. 7, the heat-transfer fluid for cooling the stator coils is an evaporating fluid, or refrigerant, such as R134a, whereas in the configuration of FIGS. 1-3, the heat-transfer fluid is a liquid. Accordingly, items labeled in FIG. 7 but not otherwise discussed here are as described above for FIGS. 1-3.

Lubricating oil is circulated to the bearings and seals. The thrust bearing assembly, acting as a viscosity pump, pumps lubricating oil through a heat exchanger that is within the stator coolant bath 303 (which is analogous to the lower coolant reservoir 155 of FIGS. 1-3). Heat from the lubricating oil passes to the refrigerant in the stator coolant bath 303, which freely convects through the ascending cooling channels through the stator core. A portion of the refrigerant evaporates and rises through ports 304 (analogous to the heat-pipe ports 149 of FIGS. 1-3) in the flange and into a diffuser condenser 305 (this is analogous to the diffuser heat-pipe condenser 147 of FIGS. 1-3). Condensed refrigerant flows back down the diffuser condenser 305, through the ports 304, and back into the stator core through descending coolant channels 133.

Refrigerant that might leak from the stator-side of the fluid-tight barrier (given by the upper barrier 122 and the lower barrier 123) into the rotor-side of the fluid-tight barrier may, in gaseous phase, be condensed within an isolated condenser from which it can be pumped back into the stator coolant bath 303. Refrigerant liquid that might accumulate in a sump 157 on the rotor-side of the fluid-tight barrier may be pumped back into the stator coolant bath 303 by the pump 158. As above, the pump 158 may be activated by a float switch, pressure sensor, or other fluid level sensor 159.

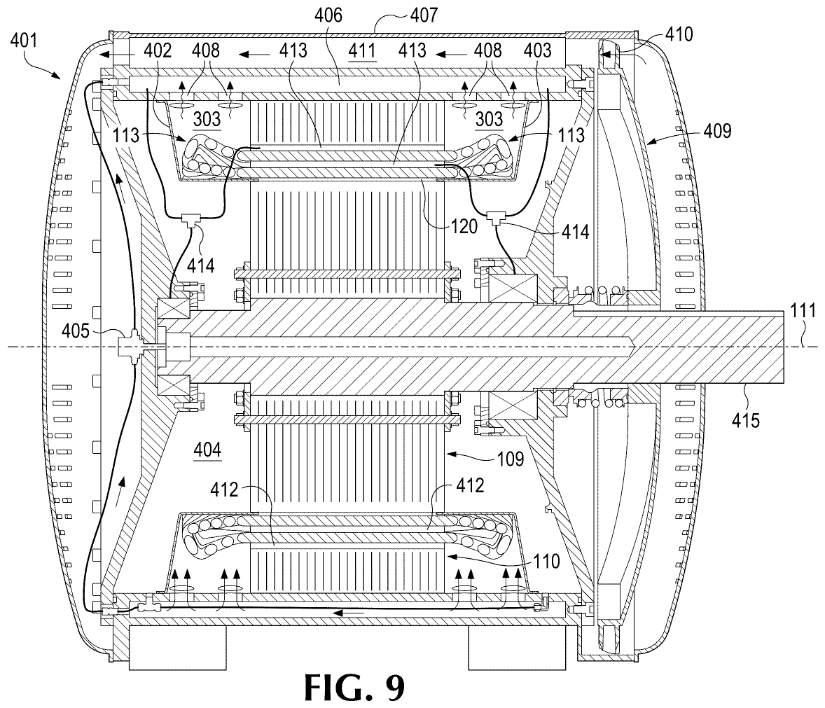

As discussed elsewhere in this disclosure, in the configuration of FIG. 7, a fractionating column (an example of which is shown as item 414 in FIG. 9) may be used to separate (very low boiling point) inert gas (if used), (low boiling point) refrigerant, (medium boiling point) water, and (high boiling point) lubricating oil from each other.

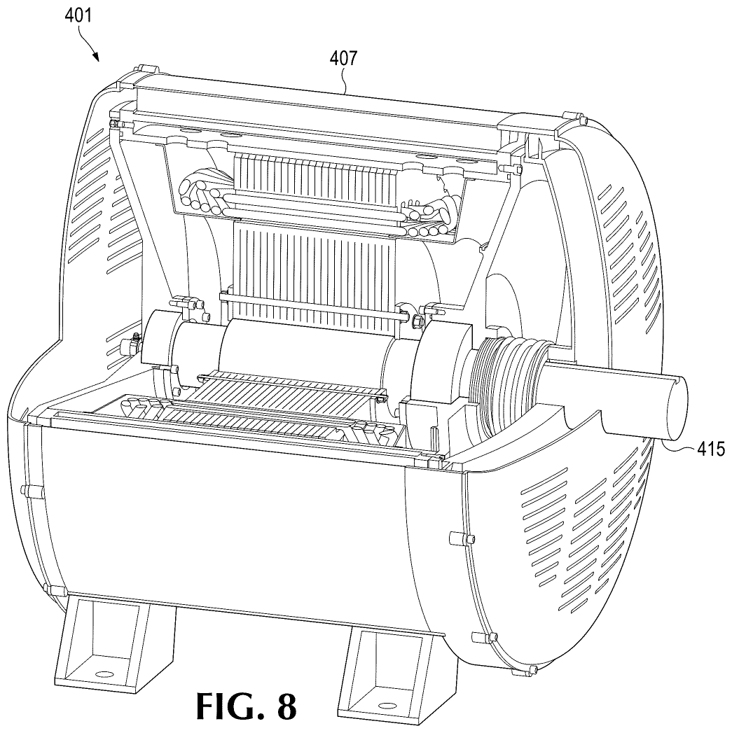

FIG. 8 is a partial sectional view showing portions of a refrigerant-cooled, rotating electrical machine 401 having an internal rotor, according to another example configuration. FIG. 9 is a sectional view of the rotating electrical machine 401 of FIG. 8. The rotating electrical machine 401 of FIGS. 8 and 9 is similar to what is described above for the rotating electrical machine 401 of FIG. 7, except that the configuration of FIGS. 8 and 9 does not include a hydromotive machine. Instead, the rotating electrical machine 401 of FIGS. 8 and 9 has a hermetically-sealed motor housing 407 that contains both heat-transfer liquid (e.g. lubricating oil) and refrigerant. Items labeled in FIGS. 8 and 9 but not otherwise discussed here are as described above for FIGS. 1-3.

The first barrier 402 and the second barrier 403 (analogous to the upper barrier 122 and the lower barrier 123 of FIGS. 1-3) limit ingress of refrigerant and lubricating oil into the rotor cavity 404. A pump returns refrigerant leaked into rotor cavity 404 to one or more locations within the refrigerant circuit, such as to condenser 406. The stator end-coils are immersed in refrigerant, which boils off when heated and escapes into the condenser 406. The condenser 406 may be co-located with the motor housing 407 or may be separately located. Passageways 408 allow refrigerant to flow as a gas from the stator coolant baths within the first barrier 402 and within the second barrier 403 to the condenser 406 and back again as a liquid. A fan 409 with fan blades 410 may be used to force cooling air through the cooling fins 411 of the condenser 406. As illustrated, the stator core includes cooling channels 412 (analogous to the ascending coolant channels 116 of FIGS. 1-3). One or more of such cooling channels 412 (see those labeled 413 in the illustrated configuration) may be configured as the heaters for fractionating columns 414, which concentrate lubrication oil to supply to the bearings that support the shaft 415. The configuration of FIGS. 8 and 9 thus provides effective cooling by means of evaporating a refrigerant immediately adjacent to its stator coils as well as low windage losses by way of maintaining a dry air gap.

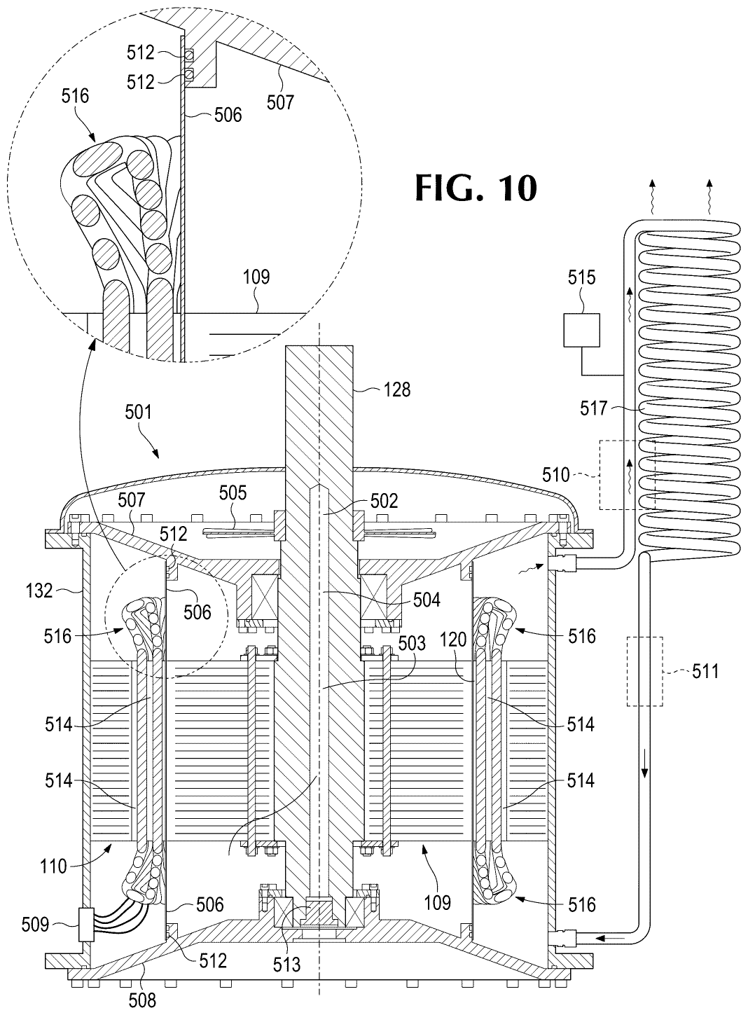

FIG. 10 is a sectional view showing portions of a refrigerant-cooled, rotating electrical machine 501 having an internal rotor, according to another example configuration that cools with two independent heat-pipe circuits. Items labeled in FIG. 10 but not otherwise discussed here are as described above for FIGS. 1-3.

The shaft incorporates a first heat pipe 502 with an evaporator portion 503 and a condenser portion 504 to remove heat from the rotor assembly and deliver the heat to a rotating heat sink 505. A second heat-pipe circuit is comprised of a coolant isolation tube 506 in conjunction with the motor-generator shaft-end bulkhead 507, the bearing-end bulkhead 508, the hermetic cable feed-through 509, and the stator housing, which together keep the heat-pipe working fluid (refrigerant R134a, for example) contained and out of the air gap. A condenser 517 transfers the latent heat of the heat-pipe working fluid to ambient air or other available medium. A refrigeration compressor 510 and associated controlled condensate return 511 may be used to deliver heat to the condenser 517 in applications where heat must be delivered at temperatures in excess of the desired stator temperature. The coolant isolation tube 506 may be sealed to the motor-generator shaft-end bulkhead 507 and to the motor-generator bearing-end bulkhead 508 with elastomeric seals 512, such as O-rings. The coolant isolation tube 506 is preferably non-conductive (to avoid eddy current losses therein) and non-magnetic (to avoid hysteresis losses therein) and impermeable to the heat-pipe working fluid. Chemically tempered glass may thus be a preferred material for the coolant isolation tube 506. A thin (0.010 inch, for example) layer of rubber may be used to support the coolant isolation tube 506 within the stator core without imparting excessive local compressive loads or shear forces. A heat-pipe fill valve 513 facilitates the introduction of the correct amount of heat-pipe working fluid into the shaft. Coolant surrounds the stator end-coils 516. The coolant channels 514 within the stator core place refrigerant immediately adjacent to the stator coils without the need to use tubular conductors that would be subject to greater eddy current losses. The coolant channels 514 facilitate refrigerant circulation.

In configurations, a pressure sensor 515 (such as a pressure switch) may be used to monitor refrigerant pressure and thereby protect the motor from damage under overload conditions. This configuration is particularly suitable for use in motor generators with permanent magnet rotors because of the relative insensitivity to a greater air gap.

### EXAMPLES

Illustrative examples of the disclosed technologies are provided below. A particular configuration of the technologies may include one or more, and any combination of, the examples described below.

Example 1 includes a machine assembly comprising a fluid-cooled, rotating electrical machine having a dry air gap, the rotating electrical machine comprising: a rotor assembly; a stator assembly on a common center with the rotor assembly and having a stator core, stator coils passing through the stator core and having stator end-coils, and an ascending coolant channel extending axially through the stator core; an annular air gap that is radially between the stator assembly and the rotor assembly; and a fluid-tight barrier between the stator end-coils and the air gap.

Example 2 includes the machine assembly of Example 1, in which the fluid-tight barrier comprises: an upper barrier between upper stator end-coils of the stator end-coils and the air gap and secured to the stator core; and a lower barrier between lower stator end-coils of the stator end-coils and the air gap and secured to the stator core.

Example 3 includes the machine assembly of any of Examples 1-2, further comprising heat-transfer fluid immersing the stator end-coils but not the air gap.

Example 4 includes the machine assembly of Example 3, in which the heat-transfer fluid is a liquid coolant.

Example 5 includes the machine assembly of Example 3, in which the heat-transfer fluid is a refrigerant.

Example 6 includes the machine assembly of any of Examples 1-5, in which the stator assembly is radially external to the rotor assembly.

Example 7 includes the machine assembly of Example 6, in which the common center is a shaft thermally coupled to the rotor assembly, the shaft comprising a heat pipe within the shaft.

Example 8 includes the machine assembly of any of Examples 6-7, further comprising: a stator housing thermally coupled to the stator assembly; and a descending coolant channel in the stator core and thermally coupled to the stator housing.

Example 9 includes the machine assembly of Example 8, the stator housing further comprising: an inner wall of the stator housing thermally coupled to the stator assembly; an outer wall of the stator housing; and a heat-pipe evaporator between the inner wall of the stator housing and the outer wall of the stator housing.

Example 10 includes the machine assembly of any of Examples 6-9, further comprising a hydromotive machine having an impeller, a pump inlet upstream of the impeller, a pump outlet downstream of the impeller, and a pump diffuser between the impeller and the pump outlet.

Example 11 includes the machine assembly of Example 10, in which the common center is a shaft thermally coupled to the rotor assembly, the shaft comprising a heat pipe within the shaft, in which a condenser portion of the heat pipe extends into the pump inlet of the hydromotive machine.

Example 12 includes the machine assembly of any of Examples 10-11, further comprising a stator housing thermally coupled to the stator assembly, the stator housing having an inner wall of the stator housing thermally coupled to the stator assembly, an outer wall of the stator housing, and a stator-housing heat-pipe evaporator in an annular space between the inner wall of the stator housing and the outer wall of the stator housing.

Example 13 includes the machine assembly of Example 12, the hydromotive machine further comprising an inner diffuser housing radially external to the pump diffuser, an outer diffuser housing radially external to the inner diffuser housing, and a diffuser heat-pipe condenser in an annular space between the inner diffuser housing and the outer diffuser housing, the machine assembly further comprising a flange between the stator housing and the hydromotive machine, the flange including one or more heat-pipe ports to connect the stator-housing heat-pipe evaporator to the diffuser heat-pipe condenser.

Example 14 includes the machine assembly of any of Examples 1-5, in which the stator assembly is radially internal to the rotor assembly.

Example 15 includes the machine assembly of Example 14, in which the common center is a rotating shaft having a heat pipe within the rotating shaft, the stator assembly further comprising a tubular stator shaft, the rotating electrical machine further comprising a chamber between the tubular stator shaft and the rotating shaft, the chamber configured to contain heat-transfer fluid.

The contents of the present document have been presented for purposes of illustration and description, but such contents are not intended to be exhaustive or limited to the disclosure in the form disclosed. Many modifications and variations will be apparent to those of ordinary skill in the art without departing from the scope and spirit of the disclosure. The aspects of the disclosure in this document were chosen and described to explain the principles of the disclosure and the practical application, and to enable others of ordinary skill in the art to understand the disclosure with various modifications as are suited to the particular use contemplated.

Accordingly, it is to be understood that the disclosure in this specification includes all possible combinations of the particular features referred to in this specification. For example, where a particular feature is disclosed in the context of a particular example configuration, that feature can also be used, to the extent possible, in the context of other example configurations.

Additionally, the described versions of the disclosed subject matter have many advantages that were either described or would be apparent to a person of ordinary skill. Even so, all of these advantages or features are not required in all versions of the disclosed apparatus, systems, or methods.

Also, when reference is made in this application to a method having two or more defined steps or operations, the defined steps or operations can be carried out in any order or simultaneously, unless the context excludes those possibilities.

The terminology used in this specification is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, or groups thereof. Hence, for example, an article “comprising” or “which comprises” components A, B, and C can contain only components A, B, and C, or it can contain components A, B, and C along with one or more other components.

It is understood that the present subject matter may be embodied in many different forms and should not be construed as being limited to the example configurations set forth in this specification. Rather, these example configurations are provided so that this subject matter will be thorough and complete and will convey the disclosure to those skilled in the art. Indeed, the subject matter is intended to cover alternatives, modifications, and equivalents of these example configurations, which are included within the scope and spirit of the subject matter set forth in this disclosure. Furthermore, in the detailed description of the present subject matter, specific details are set forth to provide a thorough understanding of the present subject matter. It will be clear to those of ordinary skill in the art, however, that the present subject matter may be practiced without such specific details.

I (or we) claim:

1. A machine assembly comprising a fluid-cooled, rotating electrical machine having a dry air gap, the rotating electrical machine comprising:
a rotor assembly;
a stator assembly on a common center with the rotor assembly and having a stator core, stator coils passing through the stator core and having stator end-coils, and an ascending coolant channel extending axially through the stator core;
an annular air gap that is radially between the stator assembly and the rotor assembly; and
a fluid-tight barrier between the stator end-coils and the air gap.

2. The machine assembly of claim 1, in which the fluid-tight barrier comprises:
an upper barrier between upper stator end-coils of the stator end-coils and the air gap and secured to the stator core; and
a lower barrier between lower stator end-coils of the stator end-coils and the air gap and secured to the stator core.

3. The machine assembly of claim 1, further comprising heat-transfer fluid immersing the stator end-coils but not the air gap.

4. The machine assembly of claim 3, in which the heat-transfer fluid is a liquid coolant.

5. The machine assembly of claim 3, in which the heat-transfer fluid is a refrigerant.

6. The machine assembly of claim 1, in which the stator assembly is radially external to the rotor assembly.

7. The machine assembly of claim 6, in which the common center is a shaft thermally coupled to the rotor assembly, the shaft comprising a heat pipe within the shaft.

8. The machine assembly of claim 6, further comprising:
a stator housing thermally coupled to the stator assembly; and
a descending coolant channel in the stator core and thermally coupled to the stator housing.

9. The machine assembly of claim 8, the stator housing further comprising:
an inner wall of the stator housing thermally coupled to the stator assembly;
an outer wall of the stator housing; and
a heat-pipe evaporator between the inner wall of the stator housing and the outer wall of the stator housing.

10. The machine assembly of claim 6, further comprising a hydromotive machine having an impeller, a pump inlet upstream of the impeller, a pump outlet downstream of the impeller, and a pump diffuser between the impeller and the pump outlet.

11. The machine assembly of claim 10, in which the common center is a shaft thermally coupled to the rotor assembly, the shaft comprising a heat pipe within the shaft, in which a condenser portion of the heat pipe extends into the pump inlet of the hydromotive machine.

12. The machine assembly of claim 10, further comprising a stator housing thermally coupled to the stator assembly, the stator housing having an inner wall of the stator housing thermally coupled to the stator assembly, an outer wall of the stator housing, and a stator-housing heat-pipe evaporator in an annular space between the inner wall of the stator housing and the outer wall of the stator housing.

13. The machine assembly of claim 12, the hydromotive machine further comprising an inner diffuser housing radially external to the pump diffuser, an outer diffuser housing radially external to the inner diffuser housing, and a diffuser heat-pipe condenser in an annular space between the inner diffuser housing and the outer diffuser housing, the machine assembly further comprising a flange between the stator housing and the hydromotive machine, the flange including one or more heat-pipe ports to connect the stator-housing heat-pipe evaporator to the diffuser heat-pipe condenser.

14. The machine assembly of claim 1, in which the stator assembly is radially internal to the rotor assembly.

15. The machine assembly of claim 14, in which the common center is a rotating shaft having a heat pipe within the rotating shaft, the stator assembly further comprising a tubular stator shaft, the rotating electrical machine further comprising a chamber between the tubular stator shaft and the rotating shaft, the chamber configured to contain heat-transfer fluid.
